(19) United States
(12) Patent Application Publication
(10) Pub. No.: US 2018/0098526 A1
(43) Pub. Date: Apr. 12, 2018

(54) Collar, band, belt, or strap, consisting of multiple methods for securing, displaying tags, charms or other adornments.

(71) Applicant: Candice Lee Brim, Holladay, UT (US)

(72) Inventor: Candice Lee Brim, Holladay, UT (US)

(21) Appl. No.: 15/231,726

(22) Filed: Aug. 8, 2016

(51) Int. Cl. A01K 27/00

(52) U.S. Cl. CPC A01K 27/006; A01K 27/001

(57) ABSTRACT

A collar primarily designed for use on dogs (although it can be used on humans or other animals) to be used as a method of displaying charms, tags, or other adornments. The method of securing the tags, charms, or other adornments will be separated which prevents the adornments from hitting against each other and making a clanking noise when the animal or person moves while wearing such collar.

### FIELD

This disclosure relates to the construction of a collar, band, belt or strap to adorn secure or identify an animal or other or other, such as a dog, cat, lion or other pet, wild animal or other, human or other. In addition, it relates to the construction of components and assembly of a structure that divide separated or displays adornments in a new and novel way.

### BACKGROUND

Collars, bands, belts or straps have long been used as a method of adornment, beautification and as a method of securing of, or displaying of certain charms, grommets and adornments which have been typically hung from an item, such as an O ring or other securing item like those traditionally found in the manufacture of animal or other collars which generally have a single or double grommet also known as an O ring and or D ring in a location of the collar as to be used to attach the animal or others ID tag, vaccination tag or jewelry items such as charms or amulets. Such adornments and amulets have been created and constructed as far back as the Egyptians, Greeks, and Romans and other societies long before we tried to adorn with them. Charms have continually been popular as a single jewelry item or multiple jewelry items especially with girls and young women. Many methods for displaying such adornments have been developed over the years wherein, tags and traditional collars have been developed and are currently in use. Some types of animal or other collars have the ability, to hang or display ID tags, vaccination tags or jewelry items such as charms on one or two grommets also known as an O ring which is manufactured directly into the animal or other collar. This has been an effective way to display ID tags, vaccination tags or jewel items such as charms but, has numerous disadvantages which will be overcome within this current disclosure.

An additional disadvantage is that it can be distracting, obtrusive or noisy when the animal or other is in motion and one or more of the ID tags, adornments, charms or other items are occupying similar space, same space, or an area with insufficient space for said item to move freely. This has been referred to as the clanking metal sound as the items are rubbing or hitting together. An example of this is when the animal or other moves, shakes or walks.

An additional flaw in traditional methods of manufacturing is resolved herein where unlike traditional methods the location of the securing element is not limited by space which allows for a proper uninhibited site path of the adornment so as to properly display said items in a pleasing manner. More specifically this provides a method wherein if the animal or other becomes detached from the owner and is noticed by an individual who would contact or notify the owner from the visible, uninhibited contact information printed on the ID tag, they are then able to safely reunite the animal or other with the owner.

Further flaw or fault in traditional methods of manufacturing are disclosed, whereas it is of critical importance that the vaccination ID tags are displayed so in the event the animal or other were detached from the owner, individuals that come in contact with that particular animal or other can easily identify weather the animal or other has been properly vaccinated and is safe to handle. This is important before physically helping and or handling an unfamiliar or visibly nervous or scared animal or other.

Finally in current methods of manufacturing collars, bands, belts or straps for the display of particular adornment whether ID tags, vaccination tags, jewelry, charms or other such items currently are not displayed in any type of uniform or specific manner as to size, location, color or other as to provide fast efficient feedback to an observer as to the health, safety status or other pertaining to the unfamiliar said animal or other. An example wherein a particular brand, location or team such as but not limited a sports team weather animal or other or other may or may not use the disclosed method of manufacturing in such a manner as the adornment in a particular position, size, color or other would specifically contain some type or method of information to benefit the individual and or organization. This would not be limited by either method of manufacturing or style design or methodology as such would be far too numerous to describe herein. Examples of such an adornment may or may not include such an item as a specific collar made from leather, nylon, plastic, organic or inorganic material in such a manner as to create a location in said collar, band, belt or strap wherein a loop, strap hole, d-ring or other type securing device installed within the device manufacturing in such a manner as to create a specific location as to the position of the adornment. In such a method of manufacturing the individual wearing, designing or developing the article in question may locate said attachment in location and in a manner, that will create the desired effect. An example would be a designer that may or may not include a location on the device wherein charms may be located within a specified range wherein such items could not by design rub, rattle, clang of interfere in any manner as to create noise, chatter or other unwanted or unappealing effects as to such that have been displayed and may or may not be disclosed herein. An additional example is provided wherein said method of manufacturing would allow an individual, company or other entity to develop products, charms, adornments of any fashion, and or function that may be attached to said loops, hooks or holes in such a manner that the individual attaching said adornments or even the end customer themselves, have the ability to customize, prioritize and otherwise display the items in a method pleasing and functional to them and their needs.

Said band may or may not contain, grommets, loops, or other methods of securing affixing or attaching items of adornment such as but not limited to charms, or other elements having or not having a single or multiple surface containing some type of configuration or symbol signifying something of importance to the wearer of said adornment. In addition, said band will contain a method of attachment, by means of a loop, grommet or other attachment method that can be applied to said band in a manner that allows the user, weather animal or other or other, to affix some type of adornment to it in multiple locations around the band, in such a manner as to keep said adornment from knocking, hitting or clanging into each other. In that if movement is created by the user that will cause or induce said adornment to strike each other to create an undesirable effect. Such an adornment typically contains an element to which our band, strap belt or collar will secure in a disclosed method in which the user can identify the distance, location and orientation of said adornment to create a defined result such as but not limited to adornments that can move freely but do not create an undesirable cling, clang, or other audible noise that is undesirable. More specifically disclosed is a method for the application of and construction of a collar, band, belt or strap, similar to, but not limited, to those used in animal or other collars, designer belts, bracelets or other devices that require an adornment to be secured in a specified location around the neck, waist or other desired location in which adornments may or may not be found desirable. In particular, the application relates to a collar, band, belt or strap that does not require the user to alter the collar to include more than the one attachment to display said adornments in a location desirable to display more than one adornment item they are attaching in a specified location as to create the desired and visible affect for display of said tag, charm or adornment.

This method of manufacturing allows for the display of any item to provide a function and a purpose whether functional in the sense that the collar, belt or band may be construed in such a manner as to contain, hold and dispense medicine such as but not limited to vaccines or medicines such as insulin or any other medically dependent item. Whereas through design or necessity, the need to be located on the body in a specific, clearly visible area as to the form and function of the belt, band, collar or other to achieve the desired effect. An example would be a collar specifically manufactured in a manner, according to this discloser wherein said collar has within or secured to it in such a manner as to create the desired location of items such as but not limited to a charm wherein the location may or may not be modified for a specific reason. Such as but not limited to, a manner wherein said collar has enough distance between adornments of any size shape or material as to not allow said adornment to interfere with each other on a given plain. In such an example the animal or other or mammal may move its head, leg or other appendage in such a manner that the adornments are dislodged from their original location but allowed to pass freely through space and in a manner as not to collide, tangle or make any nose whatsoever. In such a disclosure, an animal or other or mammal may have a collar adorned in a manner wherein as they jump or moved in any given direction, an audible sound is not given off unless said sound or vibration is intended by design. Such a manner as to bells that would ring or create noise or sound such as a bell or bells to identify the location and or disposition of said animal or other, or mammal, as intended by the individual or owner who placed the adornment item on the collar.

It is additionally disclosed that an additional method of manufacturing is wherein the hood ring or any such method of attachment may or may not be infinitely adjustable as to the location and disposition of said element within the design. Additionally, said element may or may not be manufactured into a finished product. It is additionally disclosed that said element may be designed in such a manner as to be used with a belt, band, collar or other item that has been previously presented in such a manner as to add additional functionality to a currently manufactured band. An example is given wherein an S Hook with a loop, latch or other interface is produced in such a manner that the hook may be pressed by hand into an existing product in such a manner that the element would be secured manually or by other means as to create locations within the belt, band or collar that the user may simply add functionality to an existing product.

Other alternatives have been presented to display the ID tags, vaccination tags and jewelry items such as charms, such as the more traditional animal or other collar that has one grommet in most cases, or in some less common animal or other collars two grommets also known as O rings. This is not a proper or productive way to display the items being attached to the grommet also known as the O ring as this still requires that the items share the space and are not clearly visible without physically moving the ID tags, vaccination tags or jewelry item such as charms in order to see clearly what each item represents.

### SUMMARY

The present disclosure relates to an animal or other collar designed with one or more grommets also known as O rings on the small size animal or other collar, one or more grommets also known as O rings on the medium size animal or other collar and one or more grommets also known as O rings on the large size animal or other collar through the design of the collar with which to display and attach the ID tags, vaccination tags and jewelry items such as charms on their own grommet also known as an O ring to provide each item their own space wherewith to hang from the animal or other collar free of interference with the other ID tags, vaccination tags or jewelry items such as charms to allow each item to be clearly visible. This newly developed design will be far superior to what is currently available on the market today.

There are many types of materials that can be used in the production of the animal or other collars. These may include but are not limited to leather, nylon (or similar material), plastic or also hemp but the function and added grommets also known as O rings as described herein provides for a truly superior product that has not been disclosed prior.

### BRIEF DESCRIPTION OF THE DRAWINGS

FIG. 1 is a perspective view of the overall collar displaying the added hardware in its respective locations.

FIG. 2 is a frontal view of the O Ring—Used to attach items to the collar such as ID Tags, vaccinations tags, charms or other ornamental jewelry items.

FIG. 3 is a frontal view of the Door Knocker—To be attached through the strap to securely attach items to the collar such as ID Tags, vaccination tags, charms or other ornamental items.

FIG. 4 is a frontal view of a Rivet—Used to hold the strap securely in place on the O Ring, D Ring or Buckle.

FIG. 5 is a top view of a Rivet securing the strap.

FIG. 6 is a frontal view of the D Ring, used to attach securely to the collar or strap evenly across the length of the collar.

FIG. 7 is a frontal view of the Buckle, used to fasten the strap in a full circle, to attach around the animal or others neck or other areas the collar may be placed on an animal or other, both wild and tame, or on a person.

### DETAILED DESCRIPTION OF THE DRAWINGS

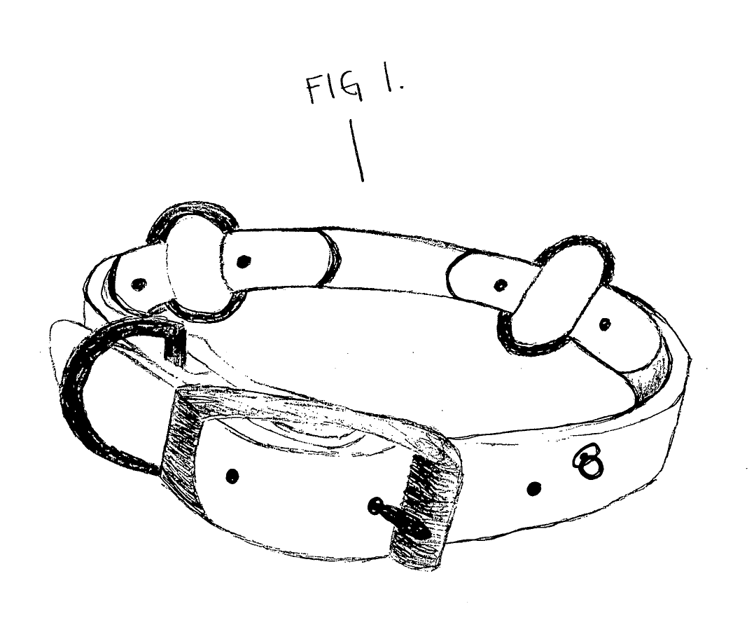

FIG. 1 is a perspective view of the overall collar displaying the added hardware in its respective locations. This is a frontal view and does not display any adornments other than the hardware included in this collar itself.

FIG. 2 is a frontal view of the O Ring—Used to attach items to the collar such as ID Tags, vaccinations tags, charms or other ornamental jewelry items. This allows for extra options to latch to the animal or other wearing the collar, as well as to utilize for securely hanging other items without rubbing or clanking together.

FIG. 3 is a frontal view of the Door Knocker—To be attached through the strap to securely attach items to the collar such as ID Tags, vaccination tags, charms or other ornamental items, to securely hang ornamental items without rubbing or clanking together such as charms, jewelry or ID/RX tags.

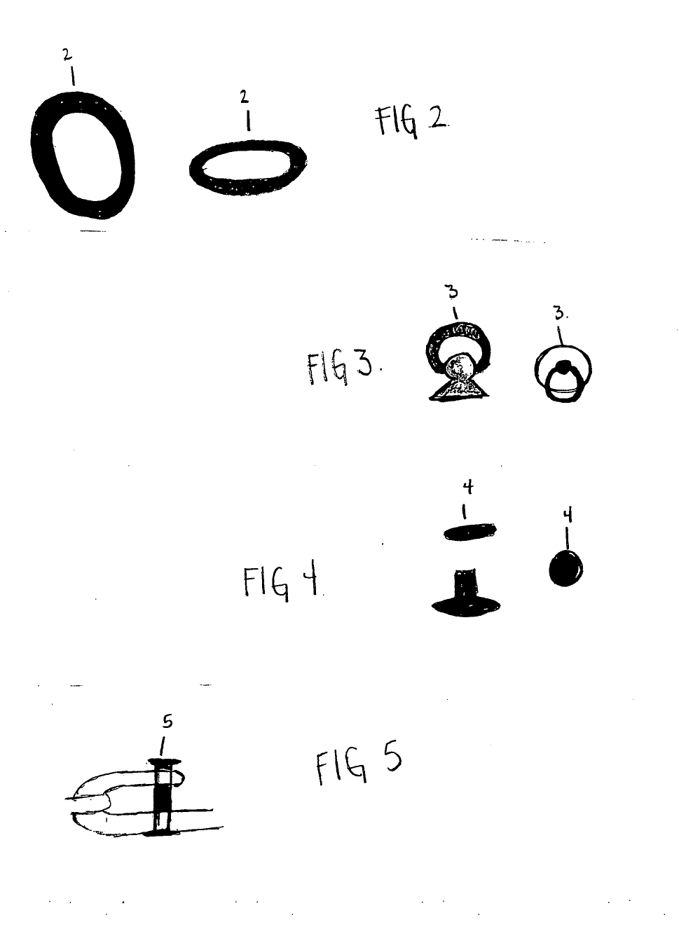

FIG. 4 is a frontal view of a Rivet—Used to hold the strap securely in place on the O Ring, D Ring or Buckle.

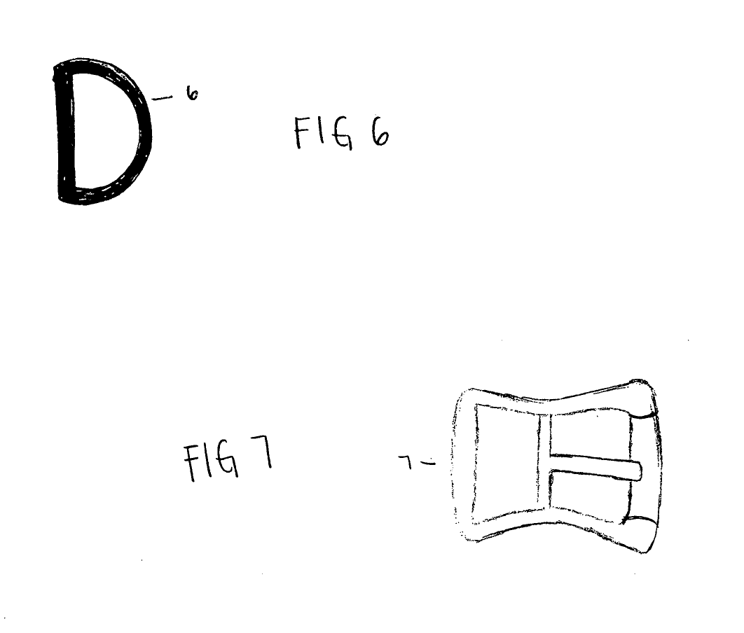

FIG. 5 is a top view of a how the Rivet holds the leather strap together to secure the hardware in place.

FIG. 6 is a frontal view of the D Ring, used to attach securely to the collar or strap evenly across the length of the collar.

FIG. 7 is a frontal view of the Buckle, used to fasten the strap in a full circle, to attach around the animal or others neck or other areas the collar may be placed on an animal or other, both wild and tame, or on a person.

### REFERENCES

The following patents and or application were referred to in the preparation of this disclosure.

| | | Publication | | |
|---|---|---|---|---|
| Citing Patent | Filing Date | Date | Applicant | Title |
| U.S. Pat. No. 6,223,559 | Jul. 20, 1999 | May 1, 2001 | Sheila J Coleman | Medical Identification Charm |
| | | | | Bracelet |
| U.S. Pat. No. 2,453,010 | Apr. 25, 1946 | Nov. 2, 1948 | John T Grafiln | Dog Collar |
| U.S. Pat. No. 3,585,743 | Jan. 28, 1970 | Jun. 22, 1971 | Carl H Jeffers | License Tag and Identification |
| | | | | Holder For Dog Collar |
| US201002892183 | May 6, 2009 | Nov. 11, 2010 | Gary Lennox | Flat Ring Pet Collar and Methods |
| | | | | of Use |

1. A collar, band, belt or strap, (Collar) consisting of multiple methods for securing, displaying tags, charms or other adornments and method of manufacturing such in a novel and unique method.
The collar in claim one within which it contains multiple elements installed in the manufacturing of such wherein said collar contains more than two methods of attachment for adornment identification, classification or other, in a clearly visible and effective manner.
The collar in claim 1 where there are one or more grommets and or other methods also known as attachment locations where said attachments may be made of various materials such as leather, nylon (or other similar material, plastic or hemp, either organic or inorganic).

2. The product disclosed herein creates a (collar) that may be small, medium or large wherein the items being displayed on the (collar) are visible and do not interfere with each other for safety and or function, and or fashion purposes.
The collar in claim 2 wherein the configuration of such may allow medical tags, and or identification tags, as well as ornamental and jeweled items to be displayed from the (collar) on one or more attachment points in a manner to be visually readable and not hindered or encumbered in any way by the other items on the animal or others collar.

3. The (collar) disclosed used in a manner as to better protect the animal or other in the event of becoming detached from the owner by allowing each ID tag or medical tag to be noticed at a short distance, in order to identify the information or message on the tags for helping the animal or other in a safe effective manner, quickly and safely, without unnecessary physical handling of the animal or other.
The disclosed article in claim three manufactured in such a method as to provide the owner of said article to have more expressive means of decorating or adorning beautification, such as jewel items or charms, to have enhanced options on the collar to place the jewelry item or charm individually and uniquely.

4. To allow more even weight disbursement for the items attached to the collar by having the attachment locations placed individually and uninhibited throughout the collar, so the weight of the collar, combined with the individual weight of the ID tags, medical tags and or jewelry items, or charms is evenly distributed allowing comfort and ease for each item and the weight distribution.
The placement of items in claim 4 for a beautiful and functional presentation of each item attached to the collar in its own individual position, without interference from any other item attached on the animal or other collar.
